(19) United States
(12) Patent Application Publication
(10) Pub. No.: US 2006/0154633 A1
(43) Pub. Date: Jul. 13, 2006

(54) Uplink sinr estimation

(76) Inventor: Hai Wang, Beijing (CN)

Correspondence Address: NIXON & VANDERHYE, PC, 901 NORTH GLEBE ROAD, 11TH FLOOR, ARLINGTON, VA, 22203, US

(21) Appl. No.: 10/542,535

(22) PCT Filed: Jan. 29, 2003
(86) PCT No.: PCT/CN03/00101

§ 371 Date: Mar. 6, 2006

(51) Int. Cl. H04B 17/00

(52) U.S. Cl. 455/226.3; 455/67.13

(57) ABSTRACT

An arrangement estimates the uplink SINR of a CDMA channel. It includes means (40) for estimating the signal power using the channelization code of the channel. A selector (28) searches for and selects an idle channelization code that is orthogonal to the channelization code of the channel. This idle code is used by further means (30) for estimating the power of interference plus noise. Means (42) then form the SINR estimate using these estimates.

### TECHNICAL FIELD

The present invention relates to estimation of the Signal to Interference plus Noise Ratio (SINR) of Code Division Multiple Access (CDMA) channels.

### BACKGROUND

The SINR is an important link performance indicator used in CDMA systems for various radio network algorithms, such as inner-loop power control. The SINR estimation is very critical, since it indirectly affects the power management at both base station and mobile station. It is required that the estimated SINR actually reflects the experienced radio link quality and, moreover, that the estimation is as accurate as possible.

The SINR estimate is formed by measuring the signal power “S”, and the interference plus noise power, “IN”. Although it is quite straightforward to measure as”, it is far from obvious how to measure ‘IN’.

A previously known method of estimating the power of interference plus noise (IN) is to re-generate the pilot symbols (after de-spreading) and calculate their average deviation from the ideal signal points. However, since the SINR is measured every time slot, there are only a few (2-8) pilot symbols available, which means that the obtainable accuracy of the IN measurement is very limited. Since the same IN estimate is used for SINR estimation of any channel, it is appreciated that these estimates will also have limited accuracy.

Another method described in [1, 2] is to reserve one downlink channelization code as an “interference plus noise measurement code” which is never used or information transfer. This method generates a downlink IN estimate by de-spreading the received signal with the reserved code. However, this method has several drawbacks. Firstly, it requires a redefinition of existing standards, since it reserves codes for IN measurements. Secondly, in order to avoid a shortage of channelization codes, a code having a high spreading factor (SF=256) is reserved. This limits the obtainable accuracy improvement, since a higher spreading factor corresponds to fewer symbols.

### SUMMARY

An object of the present invention is to improve the accuracy of the uplink SINR estimation, and especially of the interference plus noise estimation, without requiring an changes to existing standards.

This object is achieved in accordance with the attached claims.

Briefly, the present invention selects an idle (not used) channelization code, which preferably has the lowest possible spreading factor, and uses this code to estimate the power of interference plus noise. AN advantage is that since an idle code is selected, there is no need to change existing standards. Another advantage of using an idle code (such codes are always available on the uplink) is that there will be no code shortage due to SINR measurements. Furthermore, the method makes it possible to search the code tree down to lowest possible spreading factor, thereby increasing the number of symbols in the IN measurement, which will result in a very high accuracy of the IN estimate.

### BRIEF DESCRIPTION OF THE DRAWINGS

The invention, together with faker objects and advantages thereof, may best be understood by making reference to the following description taken together with the accompanying drawings, in which:

FIG. 1 is a conceptual block diagram of a prior art SINR estimation arrangement;

FIG. 2 is a diagram illustrating the structure of an OVSF code tree;

FIG. 3 is an OVSF code tree diagram illustrating idle codes when a single DPDCH is used;

FIG. 4 is an OVSF code tree diagram illustrating idle codes when 2 DPDCHs are used;

FIG. 5 is an OVSF code tree diagram illustrating idle codes when 3-4 DPDCHs are used;

FIG. 6 is an OVSF code tree diagram illustrating idle codes when 5-6 DPDCHs are used;

FIG. 7 is a conceptual block diagram of an exemplary embodiment of a SINR estimation arrangement in accordance with the present invention;

FIG. 8 is a conceptual block diagram of another exemplary embodiment of a SINR estimation arrangement in accordance with the present invention;

FIG. 9 is a diagram illustrating the performance improvement that can be obtained by the present invention; and

FIG. 10 is a flowchart illustrating an exemplary embodiment of the method in accordance with the present invention.

### DETAILED DESCRIPTION

In the following description the same reference designations will be used for the same or similar elements throughout the figures of the drawings.

Furthermore, it is assumed that only BPSK or QPSK modulation is employed, that Orthogonal Variable Spreading Factor (OVSF) codes are used as channelization codes and that the scrambling code is a complex sequence with a Long enough period. Both WCDMA and CDMA2000 fulfill these assumptions. The SINR for the de-spread symbols and de-modulated raw bits is generally defined respectively as:

$${SINR}_{sym} = \frac{{S}_{sym}}{{IN}_{sym}} = \frac{{‖ E ( symbol ) ‖}^{2}}{Var ( symbol )}$$

$${SINR}_{bit} = \frac{{S}_{bit}}{{IN}_{bit}} = \frac{{[ E ( bit ) ]}^{2}}{Var ( bit )}$$

where “E( )” denotes expectation (statistical averaging). If the phase compensation is perfect, then:

$${SINR}_{bit} = \{ \begin{matrix}2 \cdot {SINR}_{sym} , & for BPSK \\ {SINR}_{sym} , & for QPSK\end{matrix}$$

For this reason, this document will primarily discuss SINR for the de-modulated raw bits, and the term “SINR” will generally stands for “SINR_{bit}”.

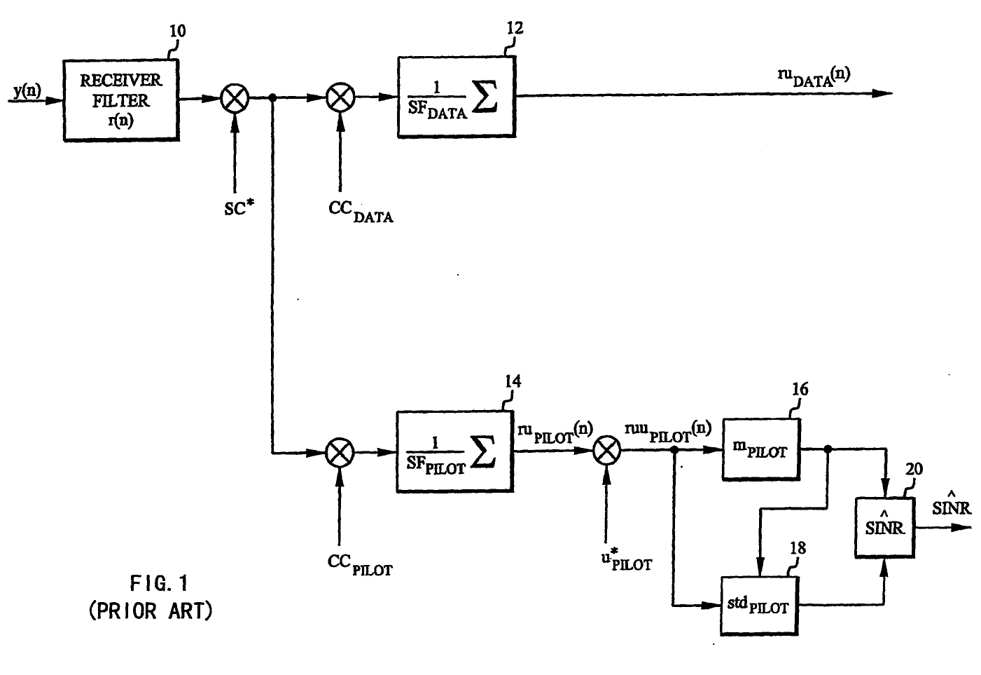

Different vendors may have different ways to estimate SINR. As an example FIG. 1 illustrates a generic CDMA receiver with function blocks to estimate the SINR by utilizing the associated pilot. The associated pilot is a pre-known symbol/bit that is transmitted at the same time (in the sense that both the multi-path channel and the interference plus noise power are almost nonvarying) and from the same transmitter as the data. Both the dedicated pilot and common pilot in WCDMA and CDMA2000 are examples of such an associated pilot.

FIG. 1 is a conceptual block diagram of a prior art SINR estimation arrangement. The received signal samples are forwarded to a receiver filter 10. Receiver filter 10 is either a multi-path channel matched filter or an equalizer. The filtered signal is de-scrambled by the complex conjugate SC* of the complex scrambling code. The de-scrambled signal is de-spread into two parallel signal streams ru_{data}(n) and ruₚᵢₗₒₜ(n) by multiplication with the respective channelization codes CC_{data} and CCₚᵢₗₒₜ and integration in integrators 12 and 14, respectively. The pilot signal branch is used for the SINR estimation by first multiplying ruₚᵢₗₒₜ(n) with the complex conjugate of the corresponding known signal uₚᵢₗₒₜ(n) for obtaining the product signal ruuₚᵢₗₒₜ(n) on which the SINR measurement is based. SINR is then estimated in blocks 16, 18 and 20 using the following equations:

$${\hat{SINR}}_{pilot} = \{ \begin{matrix}2 \cdot ( \frac{{‖ {m}_{pilot} ‖}^{2}}{{( {std}_{pilot} )}^{2}} - \frac{1}{{N}_{pilots}} ) , & for BPSK \\ \frac{{‖ {m}_{pilot} ‖}^{2}}{{( {std}_{pilot} )}^{2}} - \frac{1}{{N}_{pilots}} , & for QPSK\end{matrix} \\ Calculated in block 20 \\ where \\ {m}_{pilot} = \frac{1}{{N}_{pilots}} \cdot {\sum }_{n = 1}^{{N}_{pilots}} {ruu}_{pilot} ( n ) \\ Calculated in block 16 \\ {std}_{pilot} = \sqrt{\frac{1}{{N}_{pilot} - 1} \cdot {\sum }_{n = 1}^{{N}_{pilts}} {‖ {ruu}_{pilot} ( n ) - {m}_{pilot} ‖}^{2}} \\ Calculated in block 18$$

and Nₚᵢₗₒₜₛ is the number of pilot symbols used in the estimation (1 symbol 1 bit for BPSK and 2 bits for QPSK). This SINR estimation for the associated pilot follows the general SINR definition above, but removes the bias in the signal power estimation.

In general the SINR of a data channel can be estimated by simply scaling the estimated SINR of the associated pilot:

$${\hat{SINR}}_{data} = \frac{{MF}_{data}}{{MF}_{pilot}} \cdot \frac{{SF}_{data}}{{SF}_{pilot}} \cdot \frac{{p}_{data}}{{p}_{pilot}} \cdot {\hat{SINR}}_{pilot}$$

where
MF_{data}=modulation factor for the data (2=BPSK, 1=QPSK)
MFₚᵢₗₒₜ=modulation factor for the associated pilot (2=BPSK, 1=QPSK)
SF_{data}=the spreading factor for the data
SFₚᵢₗₒₜ=the spreading factor for the associated pilot
P_{data}=the transmission power for the data
Pₚᵢₗₒₜ=the transmission power for the associated pilot.

In WCDMA and CDMA2000 the downlink employs QPSK modulation and the uplink employs BPSK modulation.

The described method is typical for the uplink dedicated physical data channel utilizing the uplink dedicated pilot in WCDMA and CDMA2000 for SINR estimation. If this estimation method is used, then:

$$\frac{{\hat{SINR}}_{data}}{{SINR}_{data}} = \frac{{\hat{SINR}}_{pilot}}{{SINR}_{pilot}}$$

i.e. the estimated data SINR has the same accuracy as the estimated pilot SINR. The estimation accuracy is defined as:

$$accuracy = Probability ( - {X}_{dB} < 10 \cdot {log}_{10} ( \frac{{SINR}_{estimated}}{{SINR}_{actual}} ) < {X}_{dB} )$$

It is required by the “3rd Generation Partnership Project” (3GPP) that the accuracy≧90% for X_{dB}=3 dB in the interval −7 dB<10·log₁₀(SINVR_{actual})<7 dB with 80 ms averaging interval.

In WCDMA an estimated SINR should be generated every time slot (0.667 ms) and input to the inner-loop power control algorithm. If we assume that the multi-path channel and the interference plus noise power is almost nonvarying during one time slot, then the demodulated raw bits are Gaussian distributed and the SINR is fixed during the whole time slot The dedicated physical control channel has only 2-8 dedicated pilot symbols (1 symbol=2 bits) per time slot in the downlink and 3-8 dedicated pilot symbols (1 symbol=1 bit) in the uplink depending on slot format. The estimation accuracy relies on the number of associated pilots that are used in the estimation, the more pilots the higher estimation accuracy.

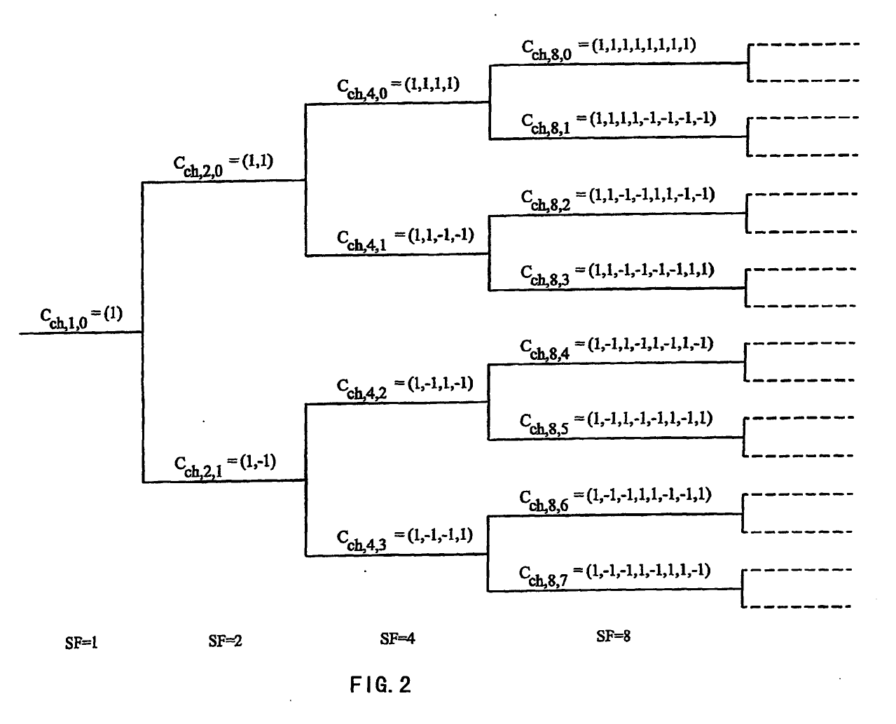

One solution to improve the estimation accuracy is to measure the effective interference plus noise power on a different measurement object than the measurement of the signal power, so that more symbols can be utilized. In accordance with the present invention, on the uplink the measurement of the effective interference plus noise power is performed on an idle code channel. An idle code is an OVSF code that is not occupied as a channelization code, or used to generate channelization code(s). FIG. 2 illustrates an OVSF code tree. The channelization codes are uniquely described as C_{ch,SF,k}, where SF is the spreading factor of the code and k is the code number, 0≦k≦SF−1. Each level in the code tree defines channelization codes of length SF, corresponding to a spreading factor of SF. The leftmost value in each channelization code word corresponds to the chip transmitted first in time. An important feature of the OVSF code tree is that channelization codes from different branches are orthogonal to each other regardless of spreading factor SF. This feature is used by the present invention, as will be described below.

In order to get an accurate estimate of the effective interference plus noise power, the spreading factor (SF) of the idle code should preferably be as low as possible, so that as many symbols as possible can be used during the same time slot. The lowest SF for an idle code is 2 if all the used codes are from the same half of the OVSF tree. More specifically, if all channelization codes are derived from the OVSF code (1, 1), then OVSF code (1, −1) can be used as the idle code, or vice versa.

This proposed idle code scheme neither requires any changes to existing standards nor creates any extra signalling burden. Since the base station already knows a user's channelization codes in order to de-spread the different code channels from this user, it can derive the best idle code by looking up the OVSF code tree. More specifically, from the 3GPP specification [3] the following conclusions can be derived for WCDMA:

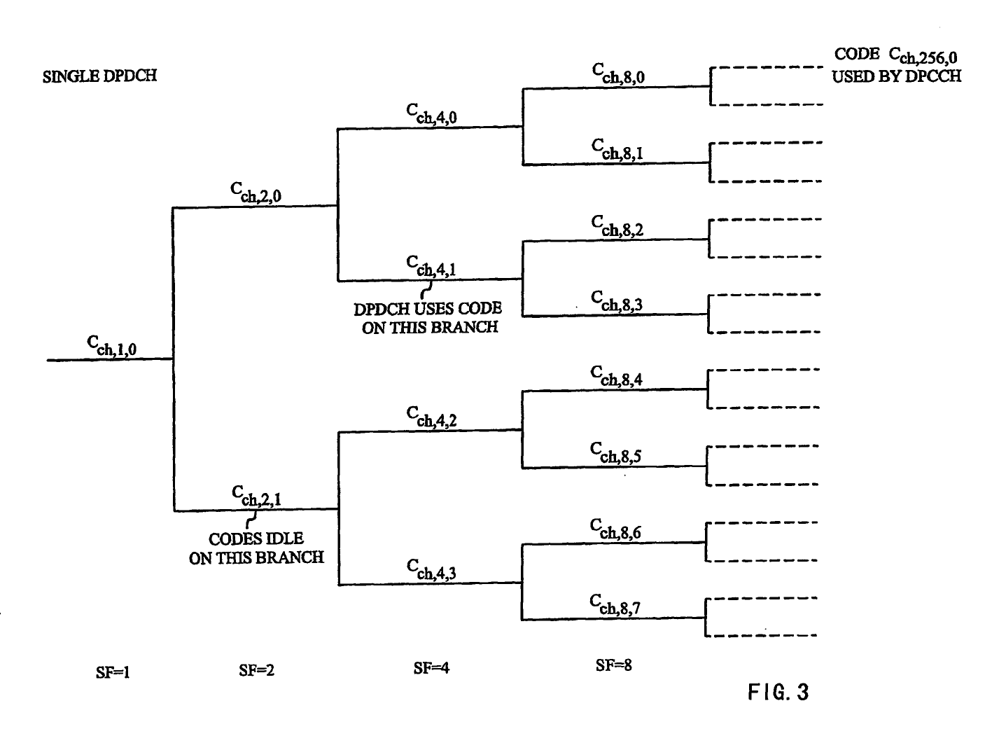

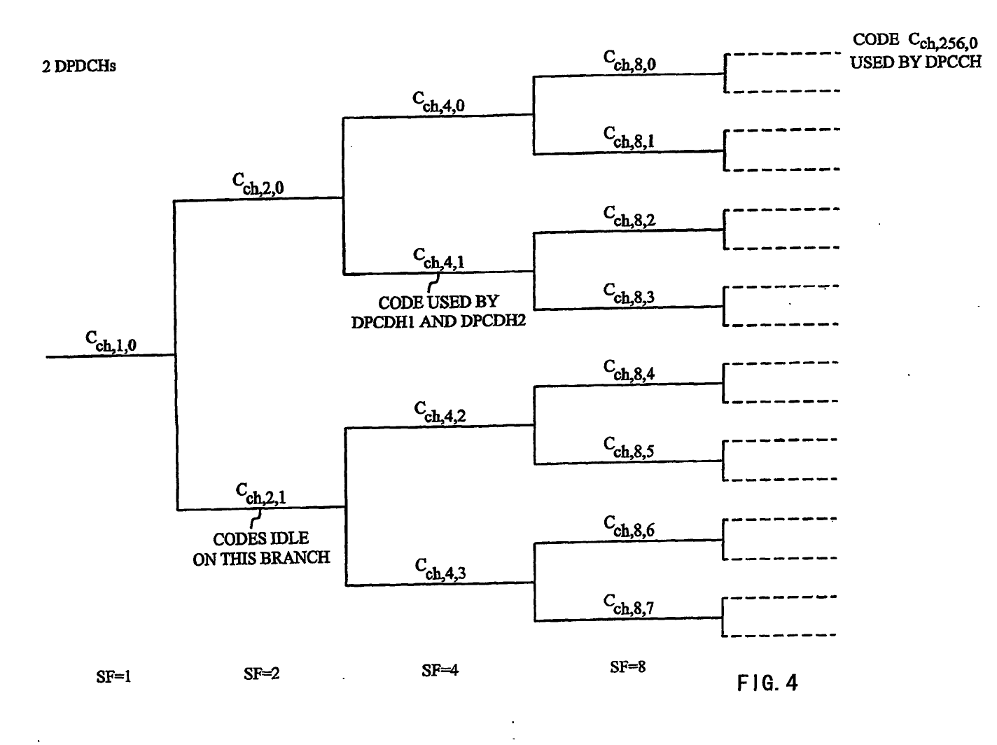

1. The channelization code C_{ch,2,1} (SF=2) is always idle when 1 or 2 DPDCHs are transmitted on the uplink, as illustrated in FIGS. 3 and 4 (in fact the entire lower branch includes idle codes, but C_{ch,2,1} has the lowest spreading factor (SF=2) and is thus preferred).

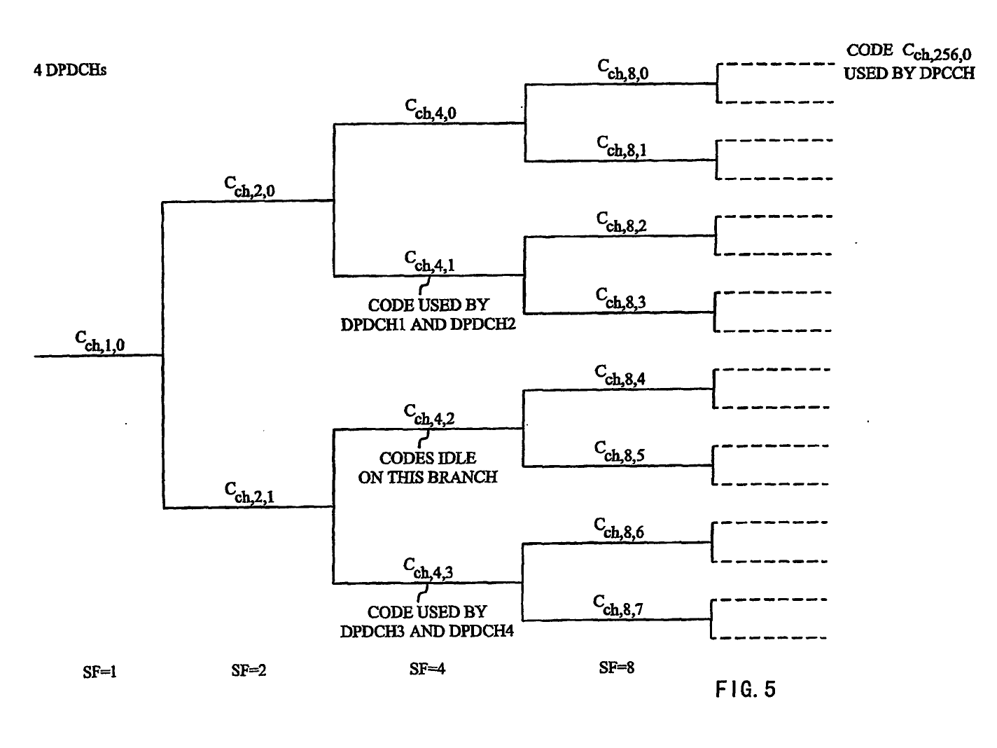

2. The channelization code C_{ch,2,1} (SF=4) (and the branch starting there) is always idle when 3 or 4 DPDCHs are transmitted on the uplink, as illustrated in FIG. 5.

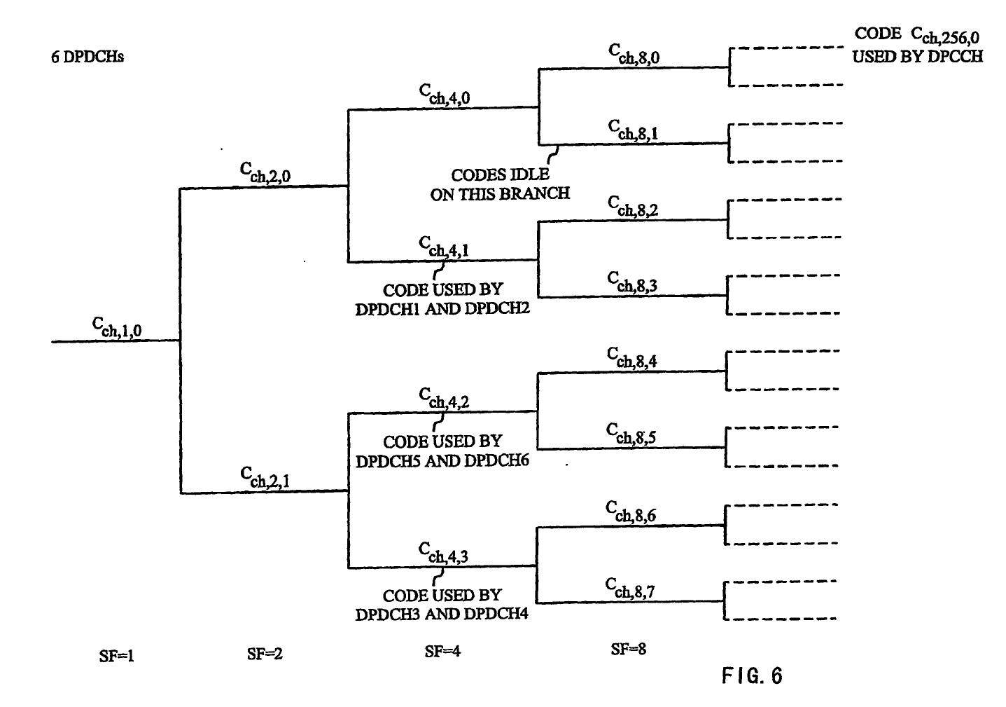

3. The channelization code C_{ch,8,1} (SF=8) (and the branch starting there) is always idle when 5 or 6 DPDCHs are transmitted on the uplink, as illustrated in FIG. 6.

The idle code channel may be viewed as a channel with zero transmission power, and by using the same analysis method as in [4] it can be shown that:

$$Var ( {ruu}_{desired} ) = \frac{{SF}_{idle}}{{SF}_{desired}} \cdot Var ( {ru}_{idle} ) = \frac{{SF}_{idle}}{{SF}_{desired}} \cdot E ( {‖ {ru}_{idle} ‖}^{2} )$$

Thus, by proper rescaling, the variance estimation of a desired channel may be performed on an idle channel instead.

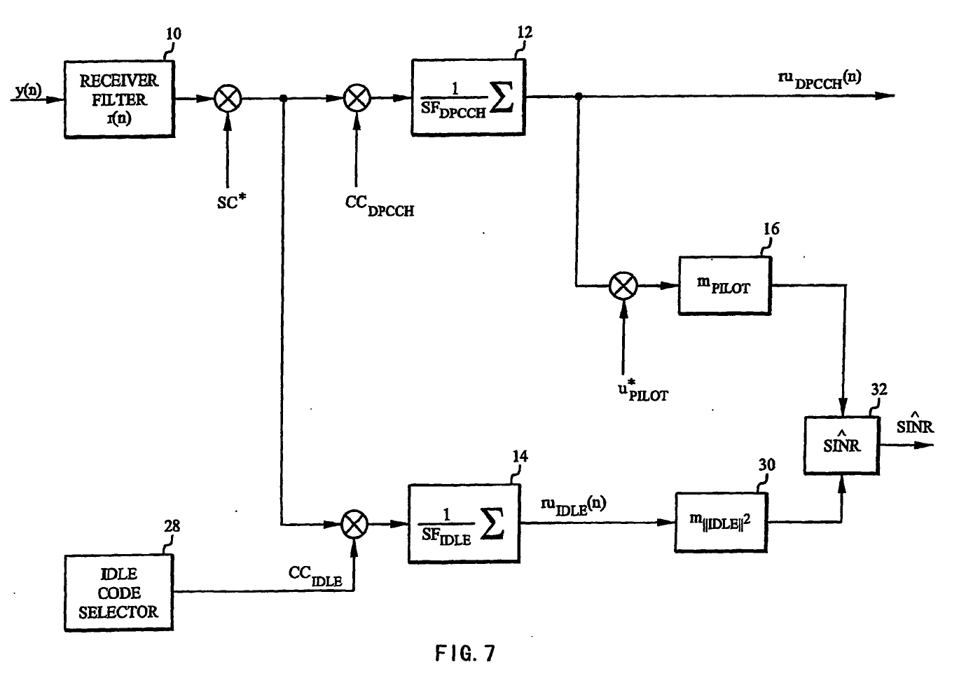

If the desired code channel has time-multiplexed pilot symbols, which is the case for the Dedicated Physical Control Channel (DPCCH), for example, then the estimated SINR for the desired code channel can be calculated as illustrated by the arrangement in FIG. 7, which illustrates the parts of a base station that are essential for explaining this exemplary embodiment of present invention. In this embodiment the de-scrambled signal is de-spread into two parallel signal streams ru_{DPCCH}(n) and ru_{idle}(n) by multiplication with the respective channelization codes CC_{DPCCH} and CC_{idle} and integration in integrators 12 and 14, respectively. The idle channelization code has been selected by an idle code selection block 28 based on the OVSF code tree in FIG. 2 and occupied codes known to the base station. It may, for example, be implemented as a simple lookup table. SINR is then estimated in blocks 16, 30 and 32 using the following equations:

$${\hat{SINR}}_{DPCCH} = 2 \cdot ( \frac{{‖ {m}_{pilot} ‖}^{2}}{\frac{{SF}_{idle}}{{SF}_{DPCCH}} \cdot {m}_{{‖ idle ‖}^{2}}} - \frac{1}{{N}_{pilot}} )$$

$$Calculated in block 32$$

$$where$$

$${m}_{pilot} = \frac{1}{{N}_{pilot}} \cdot {\sum }_{n = 1}^{{N}_{pilots}} {ruu}_{pilot} ( n )$$

$$Calculated in block 16$$

$${m}_{{‖ idle ‖}^{2}} = \frac{1}{{N}_{idle}} \cdot {\sum }_{n = 1}^{{N}_{idle}} {‖ {ru}_{idle} ( n ) ‖}^{2}$$

$$Calculated in block 30$$

and
Nₚᵢₗₒₜₛ is the number of pilot symbols used in the estimation
N_{idle} is the number of idle symbols used in the estimation.

Here the notation m_{∥idle∥}_{²} is used to indicate that the average is formed from the squared norm of the signal samples.

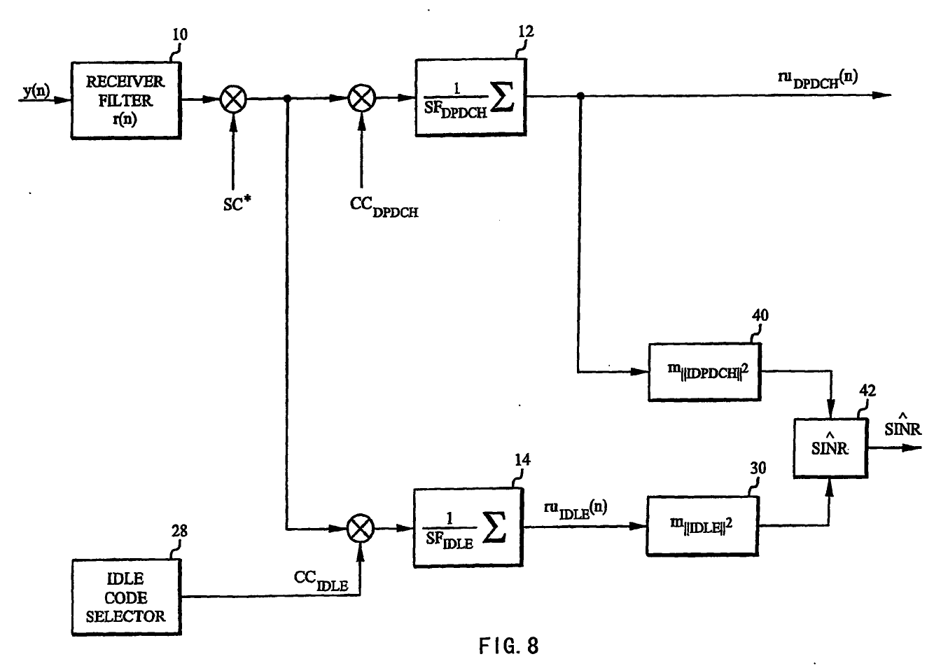

If the desired code channel does not have any pilot symbols, which is the case for the Dedicated Physical Data Channel (DPDCH), for example, then the estimated SINR for the desired code channel can still be non-coherently calculated as illustrated by the arrangement in FIG. 8, which illustrates the parts of a base station that are essential for explaining this exemplary embodiment of present invention. In this embodiment the de-scrambled signal is de-spread into two parallel signal streams ru_{DPDCH}(n) and ru_{idle}(n) by multiplication with the respective channelization codes CC_{DPDCH} and CC_{idle} and integration in integrators 12 and 14, respectively. The idle channelization code has been selected by an idle code selection block 28 based on the OVSF code tree in FIG. 2 and occupied codes known to the base station. It may, for example, be implemented as a simple lookup table. SINR is then estimated in blocks 30, 40 and 42 using the following equations:

$${\hat{SINR}}_{DPDCH} = 2 \cdot ( \frac{{‖ {m}_{DPDCH} ‖}^{2}}{\frac{{SF}_{idle}}{{SF}_{DPDCH}} \cdot {m}_{{‖ idle ‖}^{2}}} - 1 )$$

$$Calculated in block 42$$

$$where$$

$${m}_{{‖ DPDCH ‖}^{2}} = \frac{1}{{N}_{DPDCH}} \cdot {\sum }_{n = 1}^{{N}_{DPDCH}} {‖ {ru}_{DPDCH} ( n ) ‖}^{2}$$

$$Calculated in block 40$$

$${m}_{{‖ idle ‖}^{2}} = \frac{1}{{N}_{idle}} \cdot {\sum }_{n = 1}^{{N}_{idle}} {‖ {ru}_{idle} ( n ) ‖}^{2} \\ Calculated in block 30$$

and
N_{DPDCH} is the number of signal symbols used in the estimation
N_{idle} is the number of idle symbols used in the estimation.

The functionality of the arrangement of the present invention is typically implemented as a microprocessor or a micro/signal processor combination and corresponding software.

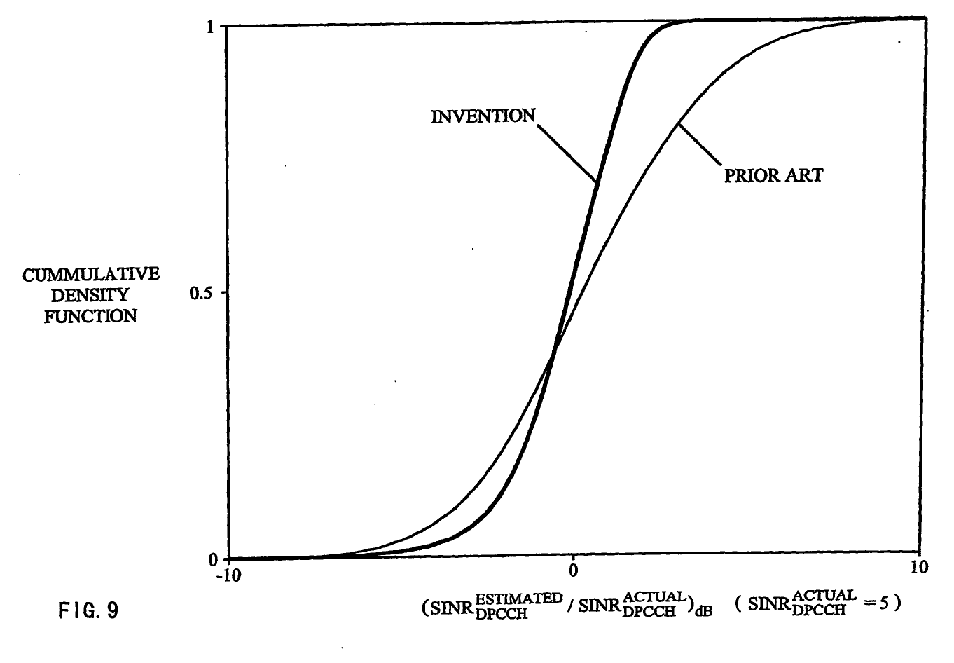

For WCDMA uplink the described prior art method only utilizes the 3˜8 dedicated pilot symbols to estimate the SINR. In contrast the method in accordance with the present invention may maximally utilize 1280 (2560/2) “idle symbols” to measure the effective interference plus noise power during one time slot. This is a main benefit of using an idle code channel (with low spreading factor) to assist the SINR estimation. The new method can also utilize all of the 10 DPCCH symbols to measure the DPCCH power, and all symbols on the DPDCH channel to measure the DPDCH power. FIG. 9 is a diagram illustrating the performance improvement that can be obtained by the present invention. The figure compares the SINR estimation based on an idle code channel (SF=2) with the SINR estimation based on 8 dedicated pilot symbols (1 symbol=1 bit due to BPSK modulation). The estimation accuracy is improved from 70% to 95% (X_{dB}=3 dB) in this example. If the dedicated pilot symbols are fewer than 8, then the improvement is even larger.

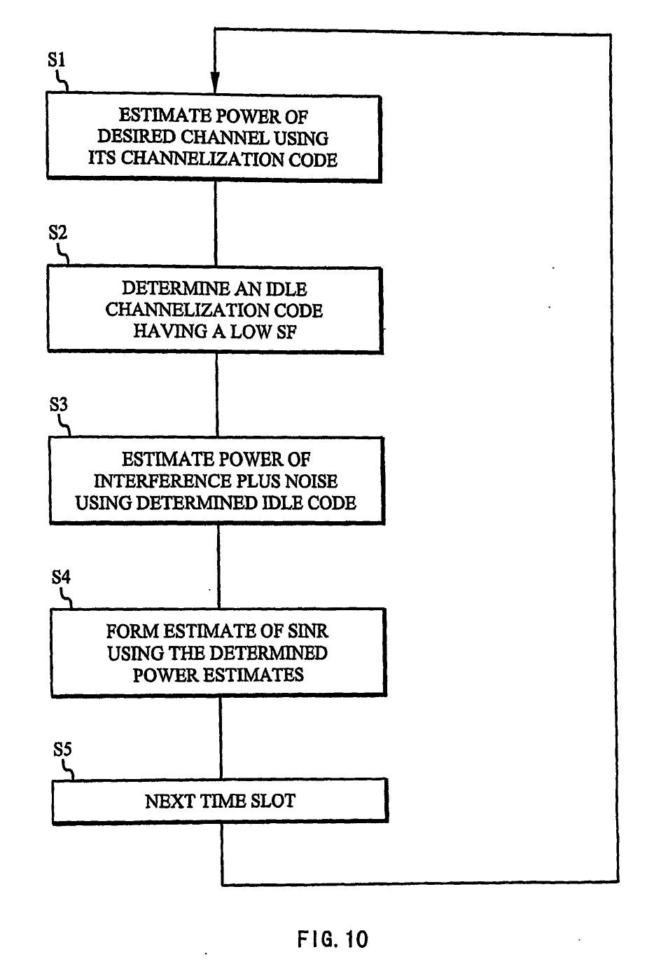

FIG. 10 is a flowchart summarizing an exemplary embodiment of the method in accordance with the present invention. Step S1 estimates the power of a desired channel using its channelization code. Step S2 searches for and selects a low SF idle channelization code from the OVSF tree using information regarding occupied channelization codes. Step S3 estimates the power of interference plus noise using the determined idle channelization code. Step S4 forms an estimate of SINR using the determined power estimates. If the channelization codes have different spreading factors, the estimates obtained in step S3 is rescaled accordingly. Finally, step S5 returns the procedure to step S1 for estimating SINR of the next time slot.

It will be understood by those skilled in the art that various modifications and changes may be made to the present invention without departure from the scope thereof, which is defined by the appended claims.

### REFERENCES

[1] TSGR1#4(99)348) “Proposal for downlink interference measurement methods”. TSG-RAN Working Group 1 meeting #4, Shin-Yokohama, Japan, Apr. 18-20, 1999.
[2] WO 00/57654.
[3] TS 25.213, “Spreading and modulation (FDD),” version 3.1.0.
[4] Wang Hai, Niclas Wiberg, “Analysis of a CDMA downlink in multi-path fading channels,” in Proceeding IEEE Wireless Communication & Networking Conference (WCNC), Orlando, Fla., Mar. 17-21, 2002, pp. 517-521.

What is claimed is

1. A method of estimating an uplink SINR of a CDMA channel, including the steps of
determining a first estimate of the signal power using the channelization code of said channel;
searching for and selecting an idle channelization code that is orthogonal to the channelization code of said channel;
determining a second estimate of the power of interference plus noise using said idle channelization code; and
forming said SINR estimate using said first and second estimates.

2. The method of claim 1, wherein said forming step includes resealing said second estimate if the channelization code of said channel and said idle channelization code have different spreading factors.

3. The method of claim 1, including selecting an idle channelization code having lowest possible spreading factor.

4. The method of claim 3, including selecting the idle channelization code C_{ch,2,1} when 1 or 2 Dedicated Physical Data Channels are used on the uplink.

5. The method of claim 3, including selecting the idle channelization code C_{ch,4,2} when 3 or 4 Dedicated Physical Data Channels are used on the uplink.

6. The method of claim 3, including selecting the idle channelization code C_{ch,8,1} when 5 or 6 Dedicated Physical Data Channels are used on the uplink.

7. A method of estimating the power of uplink interference plus noise on a CDMA channel, including the steps of
searching for and selecting an idle channelization code that is orthogonal to the channelization code of said channel;
determining an estimate of the power of interference plus noise using said idle channelization code.

8. The method of claim 7, including selecting an idle channelization code having lowest possible spreading factor.

9. An arrangement for estimating an uplink SINR of a CDMA channel, including
means (16, 40) for determining a first estimate of the signal power using the channelization code of said channel;
means (28) searching for and selecting an idle channelization code that is orthogonal to the channelization code of said channel;
means (30) for determining a second estimate of the power of interference plus noise using said idle channelization code; and
means (32, 42) for forming said SINR estimate using said first and second estimates.

10. The arrangement of claim 9, including means (32, 42) for rescaling said second estimate if the channelization code of said channel and said idle channelization code have different spreading factors.

11. The arrangement of claim 9, including means (28) for selecting an idle channelization code having lowest possible spreading factor.

12. The arrangement of claim 11, including means (28) for selecting the idle channelization code C_{ch,2,1} when 1 or 2 Dedicated Physical Data Channels are used on the uplink.

13. The arrangement of claim 11, including means (28) for selecting the idle channelization code C_{ch,4,2} when 3 or 4 Dedicated Physical Data Channels are used on the uplink.

14. The arrangement of claim 11, including means (28) for selecting the idle channelization code C_{ch,8,1} when 5 or 6 Dedicated Physical Data Channels are used on the uplink.

15. An arrangement for estimating the power of uplink interference plus noise on a CDMA channel, including
means (28) searching for and selecting an idle channelization code that is orthogonal to the channelization code of said channel;
means (30) for determining an estimate of the power of interference plus noise using said idle channelization code.

16. The arrangement of claim 15, including means (28) for selecting an idle channelization code having lowest possible spreading factor.

17. A base station having an arrangement for estimating an uplink SINR of a CDMA channel, including means (16, 40) for determining a first estimate of the signal power using the channelization code of said channel;
means (28) searching for and selecting an idle channelization code that is orthogonal to the channelization code of said channel;
means (30) for determining a second estimate of the power of interference plus noise using said idle channelization code; and
means (32, 42) for forming said SINR estimate using said first and second estimates.

18. The base station of claim 17, including means (32, 42) for resealing said second estimate if the channelization code of said channel and said idle channelization code have different spreading factors.

19. The base station of claim 17, including means (28) for selecting an idle channelization code having lowest possible spreading factor.

20. The base station of claim 19, including means (28) for selecting the idle channelization code C_{ch,2,1} when 1 or 2 Dedicated Physical Data Channels are used on the uplink.

21. The base station of claim 19, including means (28) for selecting the idle channelization code C_{ch,4,2} when 3 or 4 Dedicated Physical Data Channels are used on the uplink.

22. The base station of claim 19, including means (28) for selecting the idle channelization code C_{ch,8,1} when 5 or 6 Dedicated Physical Data Channels are used on the uplink.

23. A base station having an arrangement for estimating the power of uplink interference plus noise on a CDMA channel, including
means (28) searching for and selecting an idle channelization code that is orthogonal to the channelization code of said channel;
means (30) for determining an estimate of the power of interference plus noise using said idle channelization code.

24. The base station of claim 23, including means (28) for selecting an idle channelization code having lowest possible spreading factor.
